(19) United States
(12) Patent Application Publication
(10) Pub. No.: US 2018/0229424 A1
(43) Pub. Date: Aug. 16, 2018

(54) Resin System for Impregnating a Liner Element for Rehabilitating a Pipeline, Method for Lining a Pipeline and a Rehabilitation Device

(71) Applicant: Trelleborg Pipe Seals Duisburg GmbH, Duisburg (DE)

(72) Inventors: Andreas Bichler, Tirol (AT); Ashokanand Vimalanandan, Moers (DE)

(21) Appl. No.: 15/484,233

(22) Filed: Apr. 11, 2017

(30) Foreign Application Priority Data
Feb. 10, 2017 (DE) 102017102684.3

(51) Int. Cl. B29C 63/34; C09D 7/12; C09D 163/00; C09D 175/04; B29C 63/18; B29C 63/00; F16L 55/165

(52) U.S. Cl. CPC B29C 63/341; C09D 7/1275; C09D 163/00; B29C 2035/0827; B29C 63/18; B29C 63/0004; F16L 55/1652; C09D 175/04

(57) ABSTRACT

A resin system for impregnating a liner element made of a resin-absorbing material for rehabilitating a pipeline. In addition, the invention relates to a method for lining a pipeline by means of a liner element of resin-absorbing material and a rehabilitation device for performing the method. The resin system according to the invention comprises three components (A), (B) and (C) wherein component (A) is a reactive resin, wherein component (B) is an additive, wherein component (C) comprises nanoscale bodies, and wherein component (C) can be excited by ultrasound, UV radiation or microwave radiation to trigger the curing of the resin system. In the method according to the invention and the rehabilitation device according to the invention, a mobile curing device is used, which is passed through the inverted liner element.

### CROSS-REFERENCE TO RELATED APPLICATIONS

The present application is related to, and claims the benefit of priority from, German Patent Application Serial No. 10 2017 102 684.3, filed 10 Feb. 2017, the disclosure of which is incorporated herein by reference in its entirety.

### FIELD OF THE INVENTION

The invention relates to a resin system for impregnating a liner element made of a resin-absorbing material for rehabilitating a pipeline. In addition, the invention relates to a method for lining a pipeline by means of a liner element of resin-absorbing material and a rehabilitation device for performing the method.

### BACKGROUND

A resin system of the type mentioned at the outset is used for rehabilitating pipelines, in particular main pipes and/or lateral pipes in the sewage systems field and in the buildings field. The liner elements to be incorporated into the sewage system are impregnated with the resin system. After curing, leaky and defective sections of pipes and in particular pipe junction regions are rehabilitated. Through the curing of the resin system, the liner element is permanently bonded with the inner wall of the pipe to be rehabilitated. For this, the liner element is impregnated with the resin system, with the liner element itself being produced from resin-absorbing material and pressed onto the pipe inner wall before it is cured.

Likewise, the aforesaid method for lining a pipeline by means of a liner element of resin-absorbing material is used for rehabilitating the aforesaid pipelines.

The liner element to be impregnated with resin mostly comprises a carrier layer of resin-absorbing material, in particular a nonwoven or fibre material. Before the introduction of the liner element, the carrier layer is impregnated with the resin. After this, the liner element is conveyed into its final position on the site to be rehabilitated by means of a rehabilitation device.

The rehabilitation device is also described as a packer. For the introduction of the liner element into the pipeline, the known inversion methods, which are also referred to as eversion methods, are in particular used. After the curing of the resin, the liner element lies on the pipe inner wall in a material-locking, shape-fitting and coupled manner.

In the inversion method, a calibration hose which is configured stretchable and inflatable and in the inflated state has approximately the size and shape of the pipe section to be rehabilitated is mostly used. The calibration hose is pushed onto the rehabilitation device and fastened at both ends to the rehabilitation device by means of clamping collars, so that an airtight connection is produced. Next, the liner element impregnated with resin is applied onto the calibration hose. Alternatively, the liner element can also be introduced into the pipeline without the aid of a calibration hose, and pressed onto the pipe inner wall. For this, the liner element is preferably sealed at the end by means of a removable end cap.

The inversion, pushing on and/or curing of the liner element takes place with impacting of the calibration hoses and/or the liner element by means of a medium. In order to set the external reaction process of the resin in motion, the calibration hose is often impacted with steam and optionally exposed to electromagnetic waves or ultrasound.

For the control and guidance of the external reaction process of the resin, i.e. the curing time, various methods are known. Such methods use resin systems which for example contain microcapsules, which through the input of electromagnetic radiation and ultrasound are activated for the stimulation or acceleration of the external reaction process of the resin, i.e. the curing process.

From WO 93/15131 comes a method which can be used for pipe rehabilitation, wherein a resin system is used which contains microcapsules and can be brought to curing by ultrasound or microwave radiation. As well as the microencapsulation of a catalyst for curing the resin, the use of magnetic or metallic particles is also described.

WO 92/020504 discloses the lining of pipes with hoses of resin-absorbing material and appropriate resins, wherein the curing takes place by means of ultrasound. Relevant resin systems derive from the field of the polyester, styrene or epoxy resins.

In U.S. Pat. No. 5,634,743, a curable resin is disclosed which contains an accelerator or catalyst separate from the resin, wherein ultrasound or microwaves are used for the curing. Furthermore, methods for the lining of pipes inter alia with flexible hoses are shown. In addition, a system is taught which can introduce the energy necessary for the curing, which according to this publication can be ultrasound or also microwave energy. Likewise, the resin contains microcapsules which are destroyed by ultrasound in order to release substances such as accelerators or catalysts.

In U.S. Pat. No. 7,641,756 B2, pipe rehabilitation is discussed and methods for lining an inner wall proposed, wherein a felt can be used as material. The resin used for the curing is cured by means of UV, IR or microwave radiation and ultrasound. The multicomponent adhesive can contain at least one microencapsulated component. As resins, polyester, epoxides or polyurethanes in particular are used.

The disadvantage of all the said systems is that appropriately microencapsulated particles cannot satisfactorily become distributed in the resin-impregnated liner element. Because of their diameter, the microscale components cannot penetrate into all cavities of the liner element, so that an uneven, unsatisfactory penetration depth into the liner element is obtained. Likewise, with longer pot time of such resins systems a sedimentation of the microscale particles takes place, which results in separation. Because of the separation the applicability of these known systems is limited.

The aforesaid effects can moreover lead to human errors occurring if a resin is used in which a separation process has already begun or occurred.

The stability of resin systems which have a long pot time and additionally ensure improved penetration of the liner element is thus of the highest importance. Namely, particularly in the rehabilitation of lateral connections, a uniform distribution of such premixable resins systems with long pot time is important.

### SUMMARY OF THE DISCLOSURE

The invention is therefore based on the problem of providing a resin system, a method for rehabilitating pipelines and a rehabilitation device for performing the method of the nature mentioned at the start, which in the rehabilitation of pipelines ensures a more uniform impregnation or penetration of the liner element with the resin, whereby a uniform curing result can be obtained and the pot time increased. Likewise, through the invention the curing time should be shortened and human errors reduced. The curing time here is the time which is needed to attain a full mechanical load-bearing capacity of the resin.

To solve the problem, a resin system according to claim 1 and a method for lining a pipeline by means of a liner element according to claim 7 and a rehabilitation device to be used for performing the method according to claim 13 are proposed.

Advantageous embodiments of the resin system according to the invention, the method according to the invention and the rehabilitation device according to the invention are disclosed in the dependent claims.

The “liner elements” mentioned in the present invention are also referred to as liners, rehabilitation elements or pipe liner elements. In principle, such a liner element can be of single-component or multi-component configuration. Further, the liner element can have a main pipe liner and a lateral pipe liner, which is inverted into the lateral pipe.

The resin system according to the invention according to claim 1 and the method according to the invention according to claim 7 are used for rehabilitating a pipeline, in particular for rehabilitating a connection region between a main pipe and a lateral pipe or a lateral pipe several metres long. The main pipe is also described as the main sewer and the lateral pipe is also described as the house connection. The connection region between a main pipe and a lateral pipe is also described as a branching point. In the resin system according to the invention and the method according to the invention for rehabilitating a pipeline, a liner element made of a resin-absorbing material is used.

The resin system according to the invention comprises three components A, B and C, wherein component A is a reactive resin, component B is an additive, and component C comprises nanoscale bodies. Component C can be excited by ultrasound, microwave or UV radiation to trigger the curing of the resin system.

Thus the resin system according to the invention can be brought to curing by the application of ultrasound, microwave or UV radiation. Without an appropriate energy input, the resin system according to the invention has a long pot time. This makes it possible that the resin system according to the invention can already be premixed and merely contacted with the liner element at the time of the pipe rehabilitation, without further treatment steps of the resin system being necessary. Furthermore, through the use of nanoscale bodies in the resin system, a better distribution of these particles in the resin system is achieved and moreover a separation, i.e. sedimentation of the system, prevented. If a sedimentation takes place, this takes place with a time delay in comparison to similar microscale bodies. Also, through the possibility of premixing the system, human errors are avoided, since the resin system according to the invention is a so-called one-pot system. Furthermore, through the premixing a time saving and thus a cost saving during the rehabilitation works is achieved.

The resin system according to the invention can be used for the rehabilitation of main connections, branching points and lateral connections even with small diameter. As a result, the resin system according to the invention for impregnating a liner element made of a resin-absorbing material for rehabilitating a pipeline is available for a large range of possible uses.

The use of microwave radiation, UV radiation or ultrasound to trigger the curing contributes to a shortening of the curing time.

The resin system according to the invention can consist of various resin and polymerization systems.

Component A of the resin system can consist of any chemical basic building block for polyaddition, polycondensation, anionic or cationic polymerization, ring-opening polymerizations (e.g. ROMP) or radical polymerization reactions.

The average molecular weight (MW) of component A lies between 10-5000 g/mol, preferably between 100-2500 g/mol, more preferably between 300-900 g/mol and still more preferably between 500-700 g/mol.

The viscosity of component A at 25° C. lies between 500-6000 mPa×s, preferably between 1000-4000 mPa×s.

Examples of reactive resins for component A are allyl, bismaleimide, epoxy, phenolic polyester, unsaturated polyester, vinyl ester, polyamide, polyurethane, polyurea or silicone resins and mixtures thereof. Preferably unsaturated polyester resins, vinyl polyester resins, epoxy resins, polyurethane resins and polyurea (isocyanate resins) and mixtures thereof are used.

Commercially available polyester resins include unsaturated polyesters and vinyl polyesters, which for example can be dissolved in styrene and/or an acrylic ester. The aforesaid commercially available polyesters are mostly dissolved in a cross-linking monomer which additionally contains an inhibitor to prevention cross-linking.

In unsaturated polyesters, the diacid and the diol can be selected from a large number of components. Diacids include for example phthalic anhydride, isophthalic acid and adipic acid. As diols, propylene diol, ethylene diol, propylene glycol, ethylene glycol, diethylene glycol, dipropylene glycol, neopentyl glycol and mixtures thereof are routinely used.

Styrene is suitable as a cross-linking monomer. Further cross-linking monomers are vinyltoluene, methacrylate, α-methylstyrene and diallyl phthalate. Conventional inhibitors include hydroquinone, para-benzoquinone and tert.-butyl-pyrocatechol.

Polyester resins are routinely cured by a free radical reaction. In this, organic peroxides, such as for example peroxy esters and benzoyl peroxide, which act as catalysts, can be used. However, curing accelerators, such as for example cobalt octoate, which is normally used with methyl ethyl ketone peroxide, can also be present in the resin.

Epoxy resins are also suitable as reactive resin. The term “epoxy resin” relates to a large number of cross-linkable materials which contain an epoxide or oxirane group. The epoxide group reacts with a large range of curing mediators and curing agents.

Standard epoxy resins are based on bisphenol A and/or bisphenol F, epichlorohydrin and/or 1,6-bis(2,3-epoxypropoxy)hexane as starting materials. Other types of epoxy resins are based on the epoxidation of multifunctional structures which are obtained from phenols and formaldehyde or aromatic amines and aminophenols.

Epoxy resins can be cured at low temperatures with aliphatic polyamines or polyamides. Curing at elevated temperatures can occur with anhydrides, carboxylic acids, phenol novolac resins, aromatic amines or melamines, urea and phenol formaldehyde condensates.

Typical cross-linking mediators include dicyandiamide or polyhydroxy ethers which are provided with phenolic end groups, with imidazole accelerators. Epoxy resins of medium molecular weight can be cured via the terminal epoxide groups and the corresponding hydroxyl groups in the polymer skeleton. Epoxy resins of high molecular weight are mainly cured via the hydroxyl groups with aminoplasts or phenoplasts at elevated temperatures.

Further resin systems which can be used are polyurea (polyureas) and polyurethane resins. Starting materials for polyurea and polyurethane resins are isocyanates, preferably diisocyanates and polyisocyanates. In an advantageous embodiment, the isocyanate is selected from methylene diphenyl isocyanate (MDI), toluene 2,4-diisocyanate (TDI), hexamethylene diisocyanate (HDI), polymeric diphenylmethane diisocyanate (PMDI), naphthylene diisocyanate (NDI), isophorone diisocyanate (IPDI) and 4,4′-diisocyanatodicyclohexylmethane (H12MDI) and mixtures thereof. Likewise, polymeric di- and polyisocyanates can also be used.

Polyurethanes are synthetic resins which are obtained by a polyaddition reaction of diols (dialcohols) or polyols (polyalcohols) with di- and polyisocyanates. As the di- and/or polyol component, polyether- and polyester polyols can be used.

In this, the diols and/or polyols can be used singly or as a mixture. Likewise, the isocyanate component can consist either of a single component or mixtures of di- and/or polyisocyanates.

Polyurea (polyureas) are synthetic resins which are likewise obtained by a polyaddition reaction. In this, isocyanate components are reacted with di- and/or polyamine.

In this, the diamines and/or polyamines can be used singly or as a mixture. Likewise, the isocyanate component can consist either of a single component or mixtures of di- and/or polyisocyanates.

Polyurea resins can be cured by the use of waterglass.

Component B is an additive. Additives according to the invention are for example fillers and stabilizers.

The proportion of component B in the total weight of the resin system according to the inventions is max. 50 wt. %, preferably max. 20 wt. % and more preferably max. 10 wt. %.

In the sense of the invention, component B consists of inorganic or organic-based additives. Component B preferably consists of titanium dioxide (TiO₂), silica particles (SiO₂), aluminium oxide/aluminium hydroxide (Al₂O₃) or zinc oxide ZnO particles.

If component B consists of inorganic additives such as TiO₂, SiO₂, Al₂O₃ or ZnO particles, these have a diameter of 1 nm-750 μm, preferably 100 nm-500 μm, more preferably 100 nm-400 μm, still more preferably 200 nm-300 μm and still more preferably 200 nm-200 μm.

Component C comprises nanoscale bodies. The term “nanoscale” should be understood to mean those bodies whose average diameter lies in the nanometre range, i.e. the average diameter of the nanoscale bodies lies in the range from 1 to 999 nm. The average diameter can be determined by dynamic light scattering or electron microscopy measurements. Preferably the nanoscale bodies have an average diameter between 50 and 950 nm, more preferably between 50 and 900 nm, more preferably between 50 and 800 nm, more preferably 50 and 750 nm, more preferably 100 and 750 nm, still more preferably 150 and 750 nm, still more preferably 200 to 750 nm and most preferably 400 to 700 nm.

The nanoscale bodies can be magnetic nanoparticles and/or nanoparticles excitable by microwave radiation such as for example iron oxides. As nanoscale bodies, nanoencapsulated components and substances can also be used. In this, miniemulsion polymerization and special modified methods of the miniemulsion polymerization method for example inverse miniemulsion can be used in order to provide the nanoscale bodies.

The capsule shells of nanoencapsulated substances can consist of organic, inorganic, organic-inorganic hybrid materials or mixtures thereof and must be chemically inert towards components A, B and C. Such a capsule material can consist of polystyrene or polyurea-formaldehyde.

Nanoencapsulated components can have a degree of encapsulation per component of y=0-1, with 1 as complete encapsulation of the relevant component and with 0 as absence of encapsulation.

The nanoscale bodies can be excited to trigger the curing of the resin system by ultrasound, UV radiation and/or microwave radiation.

The triggering of the curing here can be caused by raising the temperature in the resin system. The triggering of the reaction can also be caused by release of a cross-linking molecule at room temperature. The triggering of the curing reaction can however also be triggered by a great variety of reaction mechanisms, known to those skilled in the art, which can be caused by ultrasound, UV radiation and/or microwave radiation.

The viscosity of the resin system lies between 10-15,000 mPa×s, preferably between 100-13,000 mPa×s, more preferably between 500-1,100 mPa×s, still more preferably between 750-9,000 mPa×s and most preferably between 1,000-6,000 mPa×s.

The density of the resin system is between 0.10-5.00 g/ml, preferably 0.25-4.00 g/ml, more preferably 0.50-3.50 g/ml, more preferably 0.75-3.00 g/ml, still more preferably 0.85-2.75 g/ml and most preferably between 1-2.5 g/ml.

The components A and C can be mixed in a weight ratio, A:C, of 1:x, with x between 0.00-20, preferably with x between 0.05-10, more preferably with x between 0.75-5, still more preferably with x between 0.10-1 and most preferably with x between 0.10-0.5.

In a preferable embodiment, the component C comprises a curing agent or a catalyst.

Curing agents can consist of any chemical curing agent for polyaddition, polycondensation, anionic or cationic polymerization, ring-opening polymerization (ROMP) or radical polymerization reactions. As curing agents, cross-linking molecules are used which bear various functional groups. These groups include amines, alcohols, thiols, alkenes and halogens. For example, octahydro-4,7-methano-1H-indenedimethylamine, phenol-4,4-(methylethylidene) bis-polymer with N,N-bis(2-aminoethyl)-1,2-ethanediamine, m-phenylene-bis-methylamine, 2-piperazin-1-ylethylamine, 3-aminoethyl-3,5,5-trimethylcyclohexylamine, cyclohexyl-1,2-ylenediamine, 3,6-diazaoctane-1,8-diamine, 2,4,6-tri-(dimethylaminomethyl)phenol, 2-ethylhexanoic acid and mixtures thereof can be used as curing agents.

The density of the curing agent is between 0.10-2.50 g/ml, preferably 0.20-2.00 g/ml, more preferably 0.30-1.80 g/ml, still more preferably 0.40-1.60 g/ml, still more preferably 0.45-1.50 g/ml and most preferably 0.50-1.20 g/ml.

In the sense of the invention, substances which have an influence on the course of the reaction during the curing of the resin system are described as catalysts. The catalyst in a resin system according to the invention can lower the activation energy of the reaction and thereby increase the curing rate, but is not itself consumed in the process.

Common catalysts are selected from the group of the alcohols, phenols and tertiary amines. One example is benzyldimethylamine.

Advantageously, the component C can comprise a curing agent and/or a catalyst. Preferably, component D is present encapsulated, if component D is a catalyst which accelerates and/or initiates the polymerization reaction.

In an advantageous embodiment, the resin system according to the invention has a pot time of at least 24 hours. Preferably the resin system has a pot time of at least 48 hours, more preferably at least 72 hours, still more preferably at least 7 days, still more preferably at least 28 days, still more preferably at least 2 months, still more preferably at least 4 months, still more preferably at least 6 months, and most preferably at least 7 months.

In a further advantageous embodiment, the component C contains a nanoencapsulated curing agent or catalyst, wherein the encapsulation, which consists of an inert shell or coating, can be broken open by ultrasound, UV radiation and/or microwave radiation.

The curing time of the system is less than one hour, preferably less than 45 minutes, more preferably less than 35 minutes, still more preferably less than 30 minutes, still more preferably less than 25 minutes, still more preferably less than 20 minutes and most preferably less than 15 minutes.

The curing time of resin systems according to the invention excitable with ultrasound is between 5 s-30 mins, preferably 5 s-20 mins, more preferably 10 s-20 mins, still more preferably 10 s-15 mins, still more preferably 10 s-10 mins and most preferably 10 s-5 mins on ultrasound treatment.

The curing time of resin systems according to the invention excitable with microwaves lies between 5 s-30 mins, preferably 5 s-20 mins, more preferably 10 s-20 mins, more preferably 10 s-15 mins, more preferably 10 s-10 mins and most preferably 10 s-5 mins on microwave treatment.

The curing time of resin systems according to the invention excitable with UV lies between 5 s-30 mins, preferably 5 s-20 mins, more preferably 10 s-20 mins, more preferably 10 s-15 mins, more preferably 10 s-10 mins and most preferably 10 s-5 min on UV treatment.

The curing time of resin systems according to the invention excitable with ultrasound with fully inverted liner element is between 5 s-30 mins/m, preferably 5 s-20 mins/m, more preferably 10 s-20 mins/m, more preferably 10 s-15 mins/m, more preferably 10 s-10 mins/m and most preferably 10 s-5 mins/m on ultrasound treatment.

The curing time of resin systems according to the invention excitable with microwaves with fully inverted liner element is between 5 s-30 mins/m, preferably 5 s-20 mins/m, more preferably 10 s-20 mins/m, more preferably 10 s-15 mins/m, more preferably 10 s-10 mins/m and most preferably 10 s-5 mins/m on microwave treatment.

The curing time of resin systems according to the invention excitable with UV with fully inverted liner element is between 5 s-30 mins/m, preferably 5 s-20 mins/m, more preferably 10 s-20 mins/m, more preferably 10 s-15 mins/m, more preferably 10 s-10 mins/m and most preferably 10 s-5 mins/m on UV treatment.

In addition, the invention relates to a method for lining a pipeline by means of a liner element of resin-absorbing material, wherein the liner element is in particular impregnated with the resin system according to the invention, wherein the method comprises the following steps:
introducing the liner element into the pipeline;
pressing the liner element onto the inner wall of the pipeline,
activating the resin system by energy input and curing the liner element, wherein the energy input takes place by means of ultrasound, UV radiation or microwave radiation.

In the method according to the invention, the resin system according to the invention according to claims 1 to 6 is advantageously used. It can however also be used with a different resin system.

Advantageously, the liner element is introduced into the pipeline by means of inversion.

In an advantageous embodiment of the method according to the invention, the energy input takes place during or after the inversion of the liner element into the pipeline.

Advantageously, the method has the following steps:
arranging the liner element impregnated with the resin system on a rehabilitation device which contains at least one curing unit for the resin system;
pushing the liner element into the inside of the rehabilitation device;
positioning the rehabilitation device on the pipeline section to be rehabilitated;
inverting the liner element into the pipeline;
pressing the liner element onto the inner wall of the pipeline;
activating the curing device for energy input into the resin system for the curing of the resin system.

Advantageously, the curing is effected by means of a mobile curing device, which is passed through the inverted liner element. Advantageously, the mobile curing unit is connected by means of a controllable coupling device with the liner element, in particular with an end region of a calibration hose for the inversion of the liner element or to a removable end cap of the liner element or to an end region of a tubular liner element. By means of the coupling device, the mobile curing device can be triggered in a defined manner in order to perform the curing of the inverted liner element.

Furthermore, the mobile curing device is advantageously connected with a control cable which can be connected with an inversion drum. The control cable is advantageously passed over a deflection roller.

In an advantageous embodiment, the mobile curing unit is connected with a control unit via a multifunction cable. The energy supply and control of the mobile curing device is effected via the multifunction cable.

Advantageously, for the curing of the resin system, the coupling device is controlled via the multifunction cable, so that the mobile curing unit detaches itself. After the detachment of the mobile curing device from the coupling device, the curing device for curing the resin system is passed through the liner element, in that advantageously a pulling force is applied on the multifunction cable and a braking force on the control cable. The braking force can be created by means of a braking device, in particular a cable brake.

In an advantageous embodiment, the curing device has a temperature sensor. Through the use of the temperature sensor, the energy input through the curing device can be adapted to the particular ambient conditions in order to achieve an optimal curing result. As a result, firstly energy is saved, and the curing time is shortened.

In addition, the invention relates to a rehabilitation device for performing the method according to the invention using the resin system according to the invention, wherein at least one curing device is provided for activation of the resin system by ultrasound, UV radiation or microwave radiation.

In an advantageous embodiment, the device has a first stationary curing device and a second mobile curing device, which independently of the first curing device can be passed through an inverted liner element.

Advantageously, the energy output of the two curing devices is mutually independently controllable.

In a further advantageous embodiment, the curing device is equipped with a temperature sensor.

In a further advantageous embodiment, the mobile curing device is attached on a calibration hose for the inversion of the liner element or on a removable end cap of the liner element or on an end region of a tubular liner element.

Advantageously, the mobile curing unit is connected with a control unit via a multifunction cable. The energy supply and control of the mobile curing device takes place via the multifunction cable.

Advantageously, a control cable is provided, which is connected to the mobile curing device.

The control cable is advantageously connected to an inversion drum.

Advantageously, the control cable is connected with the mobile curing device via a deflection roller. Here the deflection roller is mounted on the end region of the calibration hose, the end cap or the end region of a tubular liner element.

Advantageously, the mobile curing device is mounted via a controllable coupling device with the end region of a calibration hose for the inversion of the liner element or on a removable end cap of the liner element or on an end region of a tubular liner element. Further, the curing device can be attached on a deflection roller via the controllable coupling device. By means of the coupling device, the mobile curing device can be detached in a defined manner in order to perform the curing of the inverted liner element.

In an advantageous embodiment, the mobile curing device has several curing units.

Advantageously, at least one of the curing units contains a camera.

The inversion drum can advantageously have a cable brake, in particular with a pulling force sensor. Furthermore, a cable brake configured separately to the inversion drum can advantageously be provided.

### BRIEF DESCRIPTION OF THE DRAWINGS

The invention is explained in more detail below on the basis of the appended drawings. In this, diagrammatically:

FIG. 1 shows a vertical section through a connection region between a main pipeline and a lateral pipeline, which is rehabilitated by means of a method according to the invention according to a first embodiment with use of a calibration hose;

FIG. 2 shows a vertical section through the pipeline with a liner element pressed on by means of the method according to the invention according to the first embodiment and the curing of the everted liner element during the inversion and pressing-on;

FIG. 3 shows a vertical section through a liner element according to a second embodiment, wherein the curing unit is mounted on a removable end cap by means of a connecting means;

FIG. 4 shows an enlarged representation of the mobile curing device;

FIG. 5 shows a vertical section through a pipeline, which is rehabilitated by means of a method according to the invention according to a third embodiment; and

FIG. 6 shows an enlarged representation of the curing device according to FIG. 5.

### WRITTEN DESCRIPTION

In FIG. 1, a rehabilitation system 10 is shown, which serves for the rehabilitation of a connection region 12 between a main pipe 14, which is also described as the sewer and a lateral pipe 16, which is also described as a house connection pipe. The rehabilitation system 10 contains a rehabilitation device 18, which is also described as a packer, which has a calibration hose 20. By means of the rehabilitation device 18, a liner element 22 is conveyed onto the pipe section to be rehabilitated.

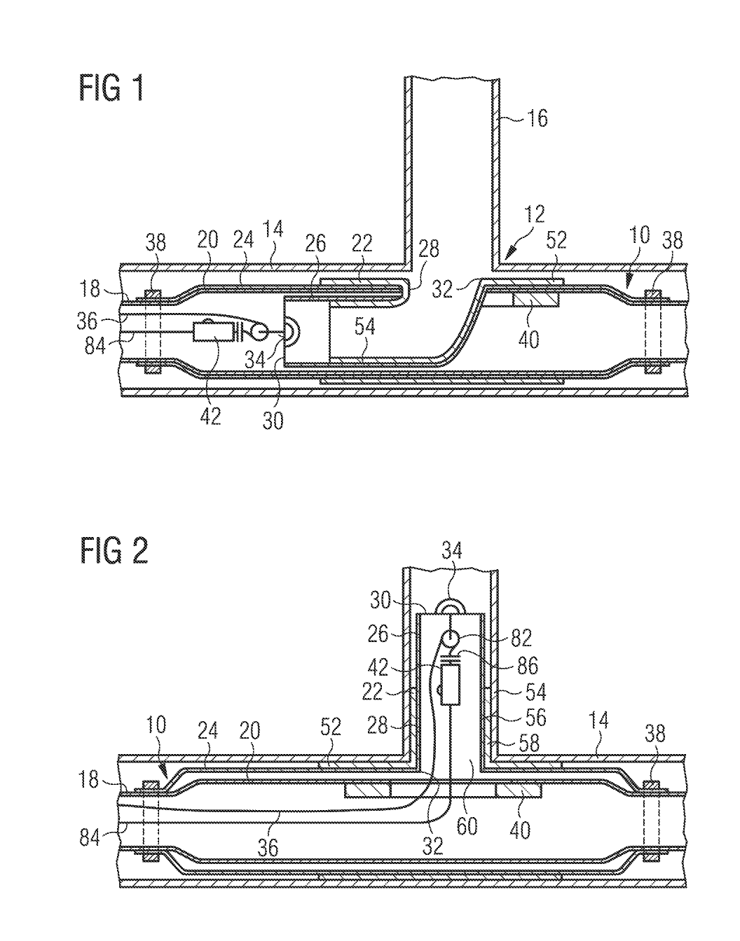

The calibration hose 20 serves for the inversion and pressing of the liner element 22 onto the pipe inner wall, as is shown in FIG. 2. The calibration hose 20 is configured stretchable and inflatable and in the inflated state has approximately the size and shape of the pipe section to be rehabilitated. The calibration hose 20 has a tubular main pipe hose 24 and a tubular lateral pipe hose 26. The lateral pipe hose 26 has a first end region 28 and a second end region 30, where the first end region 28 is connected and/or sewn in a material-locking manner with the main pipe hose 24 in the region of an opening 32 introduced in the main pipe hose 24.

The lateral pipe hose 26 projects approximately at right angles from the main pipe hose 24. The lateral pipe hose 26 can however also project from the main pipe hose 24 at a different angle. At its second end region 30, the lateral pipe hose 26 of the calibration hose 20 is closed. The second end region 30 is provided with a connecting means 34, onto which on one side a pulling means 36 is arranged.

The liner element 22 is configured approximately T-shaped and in the incorporated state is in contact with the inner wall of the pipeline. The liner element 22 has a tubular main pipe liner 52 and a tubular lateral pipe liner 54. The lateral pipe liner 54 has a first end section 56 and a second end section 58, where the first end region 56 is connected and/or sewn in a material-locking manner with the main pipe liner 52 in the region of an opening 60 introduced in the main pipe liner 52.

The liner element 22 has a carrier layer made of a continuous layer of fibre material. In particular, the carrier layer is made as multiknit nonwoven or of synthetic nonwoven and has a large number of interwoven polyester fibres and/or glass fibres. The carrier layer can be impregnated with a curable resin and in the cured state is in contact with the pipe site to be rehabilitated, in particular in a material-locking manner. Before the introduction of the liner element 22 into the pipeline, the carrier layer is impregnated with a resin. Further, the carrier layer can be provided with a coating system, not shown, of several coatings or layers bonded to one another. The individual coatings or layers can be formed of silicone or thermoplastic polyurethane. In the incorporated state, the coating points into the pipe interior.

The lateral pipe hose 26 of the calibration hose 20 is inverted into the lateral pipe 16 by application of pressure. The calibration hose 20 is mounted at both ends on the rehabilitation device 18 by means of clamping collar 38, so that an airtight connection is produced.

The resin system which is used for the impregnation of the liner element 22 comprises three components A, B and C, wherein component A is a reactive resin, component B is an additive and component C comprises nanoscale bodies. Component C can be excited to trigger the curing of the resin system by ultrasound, microwave or UV radiation, which are introduced by the curing units 40 and 42.

An advantage of the resin system with the nanoscale bodies is that it has a long pot time. This makes it possible that the resin system according to the invention can already be premixed, and merely contacted with the liner element at the time of the pipe rehabilitation, without further treatment steps of the resin system being necessary. Likewise, the resin system according to the invention makes it possible that the liner element 22 can already be impregnated with the resin system before use at the actual rehabilitation site. This means that the liner element 22 can already be impregnated with the resin system some time beforehand at a different place, so that the residence time of the rehabilitation team at the actual rehabilitation site can be minimized, as a result of which there is the possibility of reducing the rehabilitation time.

Furthermore, through the use of nanoscale bodies in the resin system a better distribution of these bodies in the resin system is obtained. The nanoscale bodies penetrate deep, even into the smallest cavities of the liner element 22. As a result, a uniform penetration depth into the liner element 22 is achieved. Later, this leads to a more uniform curing result, whereby the curing process also proceeds more rapidly. Owing to the fact that these are nanoscale bodies, separation processes, i.e. the sedimentation of the system, are prevented or considerably retarded. If a sedimentation does take place, this takes place with a time delay in comparison to corresponding microscale bodies.

The rehabilitation device 18, has a permanently installed stationary first curing device 40. This is positioned within the rehabilitation device 18. As can be seen from FIG. 2, the stationary curing unit 40 is annular in shape and surrounds the opening 60 provided in the rehabilitation device 18.

A second, mobile curing device 42 is positioned on the second end region 30 of the calibration hose 20. A control cable 36 is connected to the second mobile curing device 42 via a deflection roller 82 and a controllable coupling device 86.

Both the curing units 40 and 42 can emit ultrasound, UV radiation or microwave radiation for the activation of the resin system.

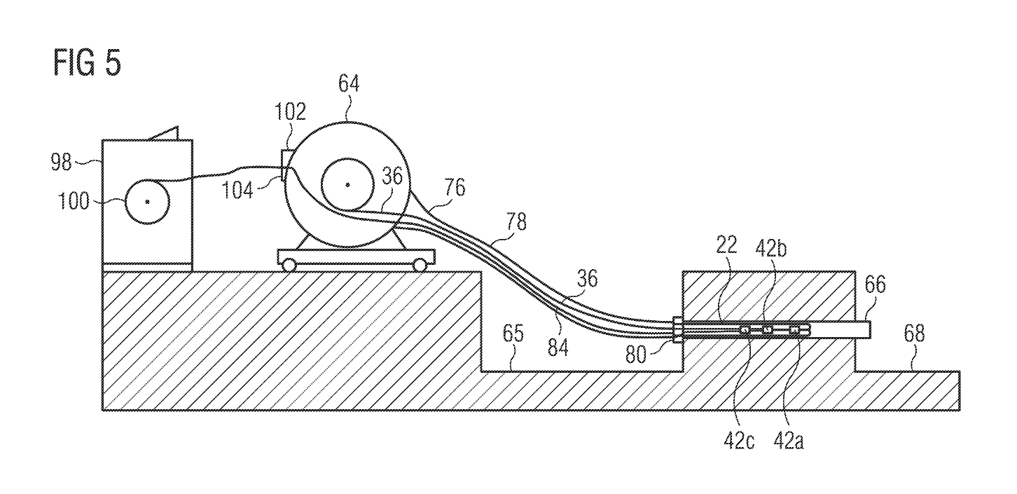

As shown in FIG. 4. both the deflection roller 82 and also the coupling device 86 are connected with the end region of the lateral pipe hose 26 or the end cap 62. The deflection roller 82 is connected by means of a suspension 94 and the coupling device 86 by means of a coupling means 96a with the end region of the calibration hose 20 or the end cap 62 or with the end region of the liner element 22. The coupling device 86 is connected with the mobile curing device 42 via a coupling means 96b.

The coupling device 86 has two annular coupling discs 87a and 87b, through the inner opening 88 whereof the control cable 36 is passed. A temperature sensor 71, with which the temperature can be monitored during the curing process, is positioned on the mobile curing device 42.

The mobile curing device 42 is supplied with power and controlled via a multifunction cable 84. The coupling device 86 is also controlled via the multifunction cable 84.

The first and second curing device 40 and 42 are configured such that they can emit ultrasound, UV radiation and/or microwave radiation. Furthermore, the first and second curing device 40 and 42 are configured in such a manner that the intensity of the emitted ultrasound, UV and/or microwave radiation can be varied. As a result it is possible to control the energy input into the resin-impregnated liner element. It is thereby ensured that the environment is not exposed to radiation.

Likewise, the radiation can thereby be optimally adapted to a great variety of liner elements with different diameters and wall thicknesses.

The first curing device 40 and the second curing device 42 can be mutually independently regulated.

Because of its ease of operation and good processability, the resin system according to the invention can be used in the rehabilitation of main connections, branching points and lateral connections even of small diameter. The resin system according to the invention for impregnating a liner element 22 is therefore usable in a wide range of applications.

A further advantage of the resin system according to the invention is that owing to the possibility of premixing the system, human errors at the rehabilitation point are avoided, since mixing of the resin system components no longer has to be performed. In addition, this possibility of premixing achieves a further time and thus cost saving in pipe rehabilitation works.

The possibility of exciting the resin system according to the invention by means of microwave radiation, UV radiation and/or ultrasound to trigger the curing contributes to the shortening of the curing time.

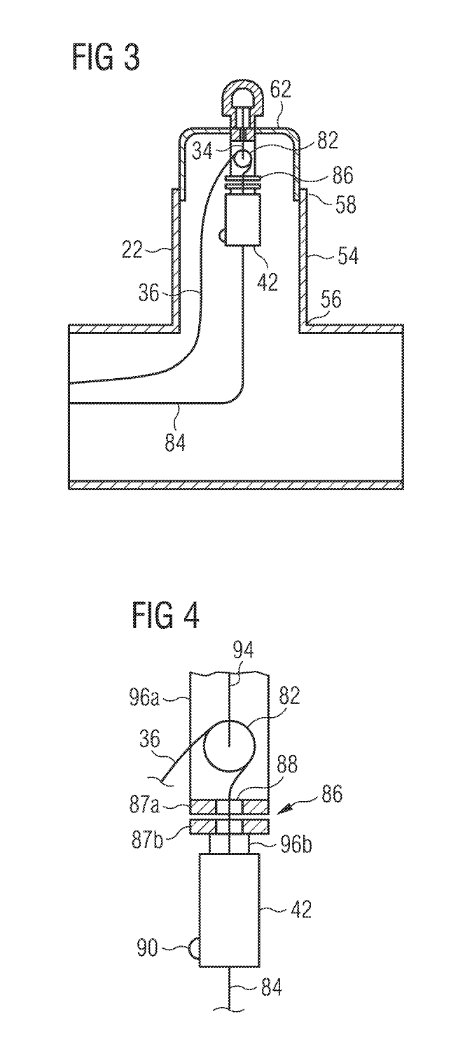

In the embodiment illustrated in FIG. 3, the liner element 22 is configured such that no calibration hose 20 in the region of the lateral pipe liner 54 is necessary for the inversion, curing and/or pressing. For this, the second end section 58 of the liner element 22 is closed at the end with a removable cap 62. The removable end cap 62 is connected and/or sewn in a material-locking manner to the second end section 58. The removable end cap 62 can also be glued to second end section 58.

The mobile curing device 42 is configured as in the embodiment according to FIGS. 1 and 2 and shown in a detailed drawing in FIG. 4. A control cable 36, which is passed over a deflection roller 82, is connected to the mobile curing device 42. Furthermore, a controllable coupling device 67 is provided, via which the mobile curing device 42 is connected to the end cap 62. The mobile curing device 42 is connected to a control device, not shown, via a multifunction cable 68.

Below, the rehabilitation of the connection region 12 by means of the method according to the invention is explained. Firstly, the liner element 22 is impregnated with the resin system according to the invention. Here, the impregnation of the liner element 22 can already be performed prior to the rehabilitation measure. This means that the impregnation of the liner element 22 with the resin system can already take place several hours or days before use.

Through the resin system according to the invention, weighing at the rehabilitation site or the use of different resins and the control of appropriate quantities to be weighed out becomes superfluous. Since the resin system has a long pot time, additional equipment expenditure can be dispensed with.

The liner element 22 impregnated with resin is applied onto the rehabilitation device 18 (packer) and transported with this to the pipe region to be rehabilitated. Here, the liner element 22 is at first in the inserted position shown in FIG. 1. By application of pressure onto the calibration hose 20, the liner element 22 is inverted into the lateral pipe 16 and pressed onto the inner wall of the main pipe 14 and the lateral pipe 16, as is shown in FIG. 2.

During the inversion process, the second mobile curing device 42 is pulled through the inverting, i.e. self-inserting hose. During this, the second curing device 42 is at a previously adjustable distance from the second end 30 of the liner element 22.

After the inversion process, the coupling device 86 is actuated for release of the mobile curing device 42. Likewise, the mobile curing device 42 is actuated. Through release of the control cable 36, the curing device 42 is passed through the inverted lateral pipe liner 54. To feed ultrasound, UV radiation and/or microwave radiation into already inverted parts of the liner element 22 and thereby to cure the resin-impregnated liner element 22.

The second end region 30 of the lateral pipe hose 26 is passed back into the starting position again by means of the pulling means 36, as a result of which the second curing device 42 is likewise returned to the starting position. During this process, a further energy input by means of ultrasound, UV radiation and/or microwave radiation into the resin-impregnated liner element 22 can be effected.

During the inversion process and before the start of the inversion process, and also after the end of the inversion process, an energy input of ultrasound, UV radiation and/or microwave radiation by means of the first stationary configured curing device 40 can also additionally take place.

In the pushed-on state, the main pipe liner 52 of the liner element 22 surrounds the main pipe hose 24 of the calibration hose 20, and the lateral pipe liner 54 of the liner element 22 surrounds the lateral pipe hose 26 of the calibration hose 20, where the lateral pipe hose 26 in the inflated state can extend through the lateral pipe liner 54, as shown in FIG. 2.

During the inversion, pressing on and/or curing, the temperature of the resin-impregnated liner element 22 can be measured by means of a temperature sensor.

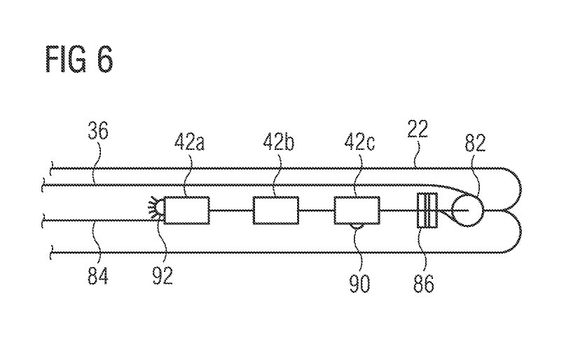

The embodiments described above according to FIGS. 1 to 3 are used in the rehabilitation of a pipe junction. In this, the lateral pipe 16 is rehabilitated via the main pipe 14. The rehabilitation device 18 has an inversion drum 64 shown in FIG. 6 and a control device 98, in which a drum 100 for rolling up the multifunction cables 84 is positioned. The inversion drum 64 has a window 102. Furthermore, a grommet 104 for the multifunction cable 84 is provided. The inversion drum 64 has a cable brake, in particular with a pulling force sensor, in order to enable slow lowering of the mobile curing device 42.

FIGS. 5 and 6 show a further practical example for rehabilitating a pipeline 66 by means of a tubular liner element 22. The pipeline 66 to be rehabilitated extends from an installation pit 65 to a target pit 68.

An inversion drum 64 is located in direct proximity to the installation pit 65 for the pipeline 66 to be rehabilitated. An air compressor, which is connected to the inversion drum 64 and creates the increased pressure necessary for the inversion, is not shown.

The inversion drum 64 has a nozzle 76, on which a flexible connecting hose is mounted 78. At the end, the connecting hose 78 has a flange 80. Rolled onto the inversion drum 64 is a control cable 36, which is passed through the connecting hose 78.

As shown in FIG. 6, the control cable 36 is passed over a deflection roller 82, which is suspended on the end region of the liner element 22. The free end of the control cable 36 is connected to a mobile curing device 42, which has several curing elements 42a, 42b, 42c positioned spaced apart from one another. A camera 92 is provided on the curing element 42a.

A multifunction cable 84 supplies the curing units 40 and 42 with power and is used for controlling the mobile curing device. Furthermore, a controllable coupling device 86 is provided, which has the structure shown in FIG. 4. The coupling device 86 is suspended on the end region of the liner element 22.

The tubular liner element 22 is firstly impregnated inside with the resin system according to the invention and closed at its ends. The free end of the liner element 22 can be closed by means of a removable end cap or a hose clamp. At this end of the liner element 22 the pulling means 36 is attached. The resin-impregnated liner element 22 is at first rolled up in the inversion drum 64 by means of the pulling means 36.

The liner element 22 is then rolled out from the inversion drum 64 until the free end of the liner element 22 emerges from the flange 80 of the connecting hose 78. The free end of the liner element 22 is everted and attached by means of a clip to the outer circumference of the flange 80.

By application of compressed air to the inversion drum 64, the liner element 22 is inverted into the pipeline 66. In the process, the liner element 22 is everted, so that the side of the liner element 22 impregnated with resin is pressed onto the inner wall of the pipeline 66.

During the inversion process, the control cable 36 unrolls from the inversion drum 64. In the course of the inversion process, the mobile curing device 42 with the liner element 22 is introduced into the pipeline 66. As soon as the liner element is fully inverted into the pipeline 66, the curing of the resin system is started. For this, firstly the coupling device 86 is actuated in order to release the mobile curing unit. Then the mobile curing device 42 is actuated for power input via the multifunction cable 84. By rolling in the multifunction cable 84 on the control device 98 and release of the control cable 36, the mobile curing device 42 is passed through the inverted liner element 22. The curing process is monitored by means of a temperature sensor 90 mounted on the curing device and a camera 92.

Through the use of the resin system according to the invention, which is cured by ultrasound, UV radiation and/or microwave radiation, the equipment expenditure for the generation of steam for curing the resin-impregnated liner system 22 after inversion of the liner element 22 in the relevant pipe section can be dispensed with. As a result, the pipe rehabilitation can be performed very quickly. Through the use of a controllable coupling device, the mobile curing device can be released in a defined manner, so that uniform curing of the resin system is ensured.

### LIST OF REFERENCE SYMBOLS

10 Rehabilitation system
12 Connection region
14 Main pipe
16 Lateral pipe
18 Rehabilitation device
20 Calibration hose
22 Liner element
24 Main pipe hose
26 Lateral pipe hose
28 First end region
30 Second end region
32 Opening
34 Connecting means
36 Control cable
38 Clamping collars
40 Stationary curing device
42 Mobile curing device
52 Main pipe liner
54 Lateral pipe liner
56 First end section
58 Second end section
60 Opening
62 End cap
64 Inversion drum
65 Installation pit
66 Pipeline
68 Target pit
76 Nozzle
78 Connecting hose
80 Flange
82 deflection roller
84 Multifunction cable
96 Coupling device
87a,87b Coupling discs
88 Internal opening
90 Temperature sensor
92 Camera
94 Suspension
96a,96b Connecting means
98 Control device
100 Drum
102 Window
104 Grommet

The invention in which an exclusive property or privilege is claimed is defined as follows:

1. A resin system for impregnating a liner element made of a resin-absorbing material for rehabilitating a pipeline, the resin system comprising three components (A), (B) and (C), wherein component (A) is a reactive resin, wherein component (B) is an additive, wherein component (C) comprises nanoscale bodies, and wherein component (C) can be excited with ultrasound, UV radiation or microwave radiation to trigger curing of the resin system.

2. The resin system according to claim 1, wherein component (C) comprises a curing agent and/or a catalyst (D).

3. The resin system according to claim 1, wherein the resin system has a pot time of at least 24 hours.

4. The resin system according to claim 1, wherein the resin system is an epoxy resin system or a polyurethane resin system.

5. The resin system according to claim 1, wherein the component (C) contains a nanoencapsulated curing agent or catalyst, and wherein the encapsulation, which comprises an inert shell or coating, can be broken open by ultrasound, UV radiation or microwave radiation.

6. The resin system according to claim 1, wherein the curing time of the system is less than one hour.

7. A method for lining a pipeline with a liner element of resin-absorbing material, comprising the following steps:
providing a liner element impregnated with a resin system comprising three components (A), (B), and (C), wherein component (A) is a reactive resin, wherein component (B) is an additive, wherein component (C) comprises nanoscale bodies, and wherein component (C) can be excited with ultrasound, UV radiation or microwave radiation to trigger curing of the resin system;
introducing the liner element into a pipeline;
pressing the liner element onto the inner wall of the pipeline; and
activating the resin system by energy input and curing the liner element, wherein the energy input takes place by any of ultrasound, UV radiation, or microwave radiation.

8. The method according to claim 7, wherein the introduction of the liner element into the pipeline takes place by means of inversion.

9. Method according to claim 8, wherein the energy input takes place during or after the inversion of the liner element into the pipeline.

10. The method according to claim 8, further comprising the following steps:
arranging the liner element impregnated with the resin system on a rehabilitation device, which contains at least one curing device for the resin system;
everting the liner element into the inside of the rehabilitation device;
positioning the rehabilitation device on the pipeline section to be rehabilitated;
inverting the liner element into the pipeline;
pressing the liner element onto the inner wall of the pipeline; and
activating the curing device for energy input into the resin system for curing the resin system.

11. The method according to claim 7, wherein the curing is effected by a mobile curing device which is passed through the inverted liner element.

12. The method according to claim 7, wherein the curing device contains a temperature sensor with which the temperature during the curing is monitored.

13. A rehabilitation device for lining a pipeline with a liner element of resin-absorbing material, wherein the liner element is impregnated with a resin system comprising three components (A), (B) and (C), wherein component (A) is a reactive resin, wherein component (B) is an additive, wherein component (C) comprises nanoscale bodies, and wherein component (C) can be excited with ultrasound, UV radiation or microwave radiation to trigger curing of the resin system, the rehabilitation device comprising:
at least one curing device for the activation of the resin system by one of ultrasound, UV radiation, or microwave radiation.

14. The rehabilitation device according to claim 13, wherein a first stationary curing device and a second mobile curing device is provided, which can independently of the first curing device be passed through an inverted liner element.

15. The rehabilitation device according to claim 14, characterized in that the energy output of the two curing devices is mutually independently controllable.

16. The rehabilitation device according to claim 13, wherein the curing device contains a temperature sensor.

17. The rehabilitation device according to claim 13, wherein the mobile curing device is mounted on a calibration hose for inverting the liner element or a removable end cap of the liner element or on an end region of a tubular liner element.

18. The rehabilitation device according to claim 13, wherein the mobile curing device is connected to a control device via a multifunction cable.

19. The rehabilitation device according to claim 13, wherein a control cable is provided, which is connected to the mobile curing device.

20. The rehabilitation device according to claim 19, wherein the control cable is connected to an inversion drum.

21. The rehabilitation device according to claim 13, wherein the control cable is connected to the mobile curing device via a deflection roller.

22. The rehabilitation device according to claim 13, wherein the mobile curing device is attached via a controllable coupling device to an end region of a calibration hose for the inversion of the liner element or to a removable end cap of the liner element or to an end region of a tubular liner element.

23. The rehabilitation device according to claim 13, wherein the mobile curing device contains a plurality of curing units.

24. The rehabilitation device according to claim 23, wherein the mobile curing device contains a camera.

25. The rehabilitation device according to claim 13, wherein the inversion drum has a cable brake in particular with a pulling force sensor.
